(19) United States
(12) Patent Application Publication
(10) Pub. No.: US 2026/0230260 A1
(43) Pub. Date: Aug. 6, 2026

(54) METHODS FOR CONFIGURATION, MEASUREMENT, AND REPORTING OF MULTIPLE RS RESOURCE SETS FOR AI/ML SYSTEMS

(71) Applicant: InterDigital Patent Holdings, Inc., Wilmington, DE (US)

(72) Inventors: Haseeb Ur Rehman, Winnipeg (CA); Young Woo Kwak, Woodbury, NY (US); Shahab Hamidi-Rad, Sunnyvale, CA (US)

(73) Assignee: InterDigital Patent Holdings, Inc., Wilmington, DE (US)

(21) Appl. No.: 19/044,114

(22) Filed: Feb. 3, 2025

(51) Int. Cl. H04L 5/00; H04B 7/06; H04W 8/22

(52) U.S. Cl. CPC H04L 5/0051; H04B 7/0626; H04W 8/22

(57) ABSTRACT

A WTRU may receive a configuration of one or more reference signal (RS) resource sets. The WTRU may determine to activate a subset of the plurality of RS resource sets based on one or more of: a comparison between a measurement time instance and a first threshold, or a comparison between a time from latest activation of at least one of the RS resources and a second threshold. The WTRU may perform measurements on the activated subset of the plurality of RS resource sets, and may transmit, to the network, a channel state information (CSI) report comprising one or more measured values and information associated with the activated subset. The WTRU may transmit the CSI report in two or more (e.g., two) separate parts. For example, a first part may include the information associated with the activated subset, and the second part may include the measured values.

### BACKGROUND

Artificial intelligence/machine learning (AI/ML) for new radio (NR) air interface may have one or more of the following objectives for beam management. Downlink (DL) transmission (Tx) beam prediction for both wireless transmit/receive unit (WTRU)-sided models and network (NW)-sided models may include one or more of spatial-domain DL Tx beam prediction for Set A of beams based on measurement results of Set B of beams (“BM-Case1”) or temporal DL Tx beam prediction for Set A of beams based on the historic measurement results of Set B of beams (“BM-Case2”). Signalling/mechanism(s) to facilitate LCM operations specific to the Beam Management use cases, if any, may be specified. Method(s) to ensure consistency between training and inference regarding NW-side additional conditions (e.g., if identified) for inference at the WTRU may be enabled. A common framework design to support both BM-Case1 and BM-Case2 may be used.

In beam management procedures, one or more (e.g., all) of the beams in a cell may be transmitted and measured to identify a best beam and receive channel(s) and/or signal(s). However, in AI/ML based DL Tx beam prediction, RSs for (e.g., only) selected beams may be transmitted, and the AI/ML model may estimate qualities of other beams based on measurements of the selected beams. This technology may be used to improve performance and/or complexity in conventional beam management aspects, including beam prediction in time, and/or spatial domain for overhead and latency reduction, beam selection accuracy improvement, and so forth.

### SUMMARY

Methods, systems, and instrumentalities for configuring, performing measurements, and reporting from multiple RS resource sets for BM-Case 2 (e.g., temporal prediction) are disclosed herein. One or more of the methods disclosed herein may be implemented by a wireless transmit/receive unit (WTRU) and/or a UE, for example via a processor thereof.

A WTRU may receive, from a network (e.g., gNB), a configuration of one or more (e.g., a plurality of) reference signal (RS) resource sets, wherein each RS resource set comprises one or more RS resources. The WTRU may determine to activate a subset of the one or more RS resource sets based on one or more of: a comparison between a measurement time instance and a first threshold, or a comparison between a time from latest activation of at least one of the RS resources and a second threshold. For example, the WTRU may determine that a first RS resource set of the one or more RS resource sets has a largest number of associated RSs with RS beam qualities measured at the measurement time instance that are greater than the threshold, and may activate the first RS resource set. Additionally and/or alternatively, the WTRU may determine that a second RS resource set has a largest overlap with one or more RSs associated with highest beam qualities measured at the measurement time instance, and may activate the second RS resource set. The measurement time instance may be a latest measurement time. The WTRU may determine, for a (e.g., each) RS resource set of the one or more RS resource sets, a respective time from latest activation, determine that a respective time from latest activation for a third RS resource set of the one or more RS resource sets is greater than the second threshold, and activate the third RS resource set. The WTRU may perform measurements on the activated subset of the one or more RS resource sets, and may transmit, to the network, a channel state information (CSI) report comprising one or more measured values and information associated with the activated subset. The WTRU may transmit the CSI report in two or more (e.g., two) separate parts. For example, a first part may include the information associated with the activated subset, and the second part may include the measured values.

The WTRU may determine a number of RS resource sets to activate based on, for example, one or more of a speed of the WTRU or a capability of the WTRU. For example, the WTRU may compare the speed of the WTRU to a third threshold and determine the number of RS resource sets to activate based on the comparison between the speed of the WTRU and the third threshold (e.g., a first number may be activated if the speed is less than the third threshold, and a second number may be activated if the speed is greater than the third threshold). Additionally and/or alternatively, the WTRU may compare a CSI-processing unit availability of the WTRU to a fourth threshold and determine the number of RS resource sets to activate based on the comparison between the CSI-processing unit availability of the WTRU and the fourth threshold (e.g., a first number may be activated if the CSI-processing unit availability is less than the fourth threshold, and a second number may be activated if the CSI-processing unit availability is greater than the fourth threshold). The RS resource sets may be associated with temporal downlink transmission prediction based on historic measurement results of a Set B.

A WTRU may receive, from a network, a configuration of one or more reference signal (RS) resource sets, wherein each RS resource set comprises one or more RS resources. The WTRU may determine to activate one or more RS resources of the one or more RS resource sets based on a time value and a threshold. For example, the WTRU may determine, based on the time value, a measurement time instance of RS measurements, determine that a first RS resource set has a largest number of associated RSs with RS beam qualities measured at the measurement time instance that are greater than the threshold, and activate the first RS resource set. The WTRU may perform measurements on the activated one or more RS resources and transmit, to the network, a channel state information (CSI) report comprising one or more measured values and information associated with the activated one or more RS resources.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of dynamic activation of RS resource sets based on one or more criteria.

### DETAILED DESCRIPTION

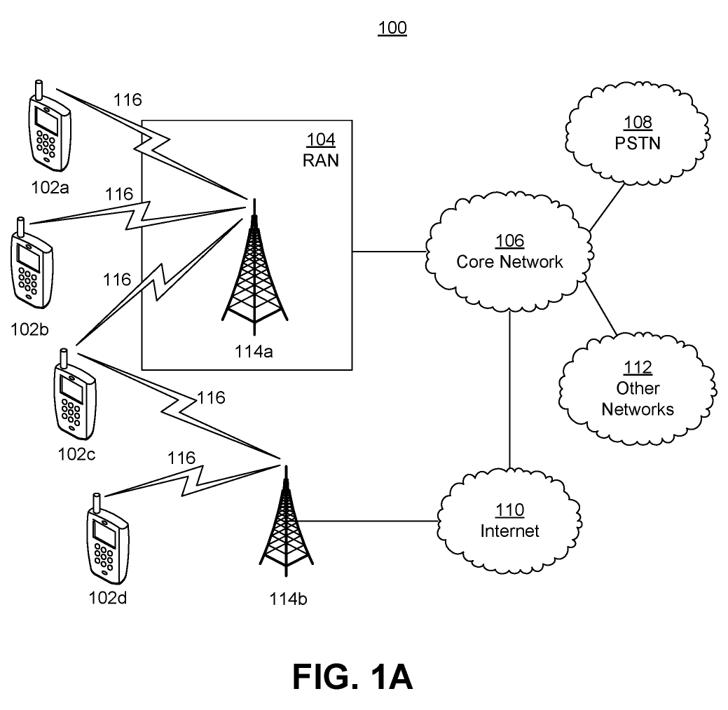

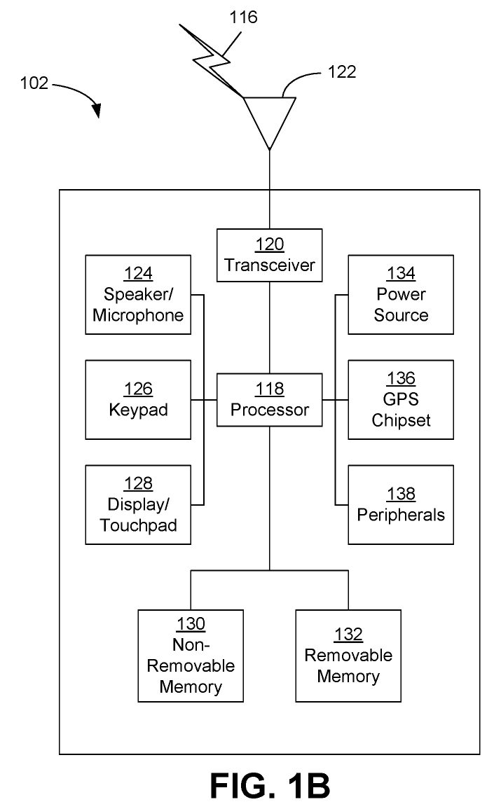

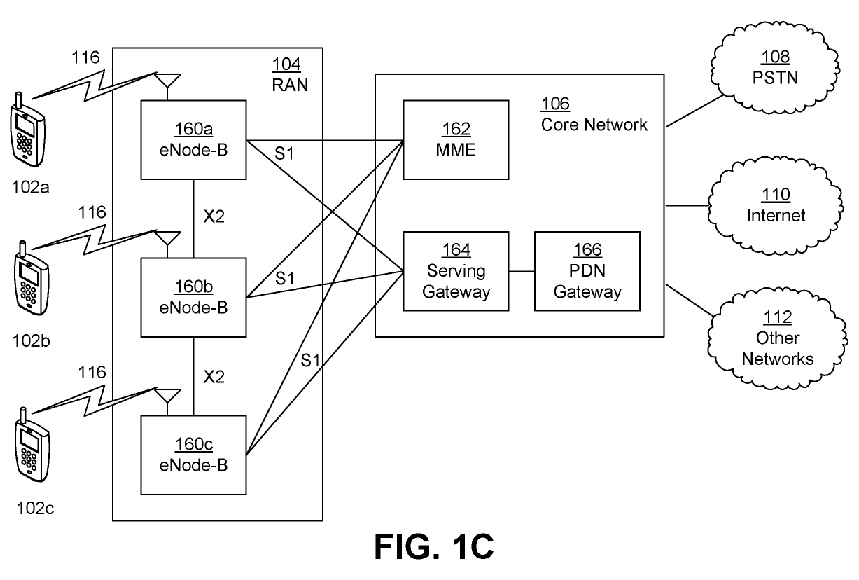

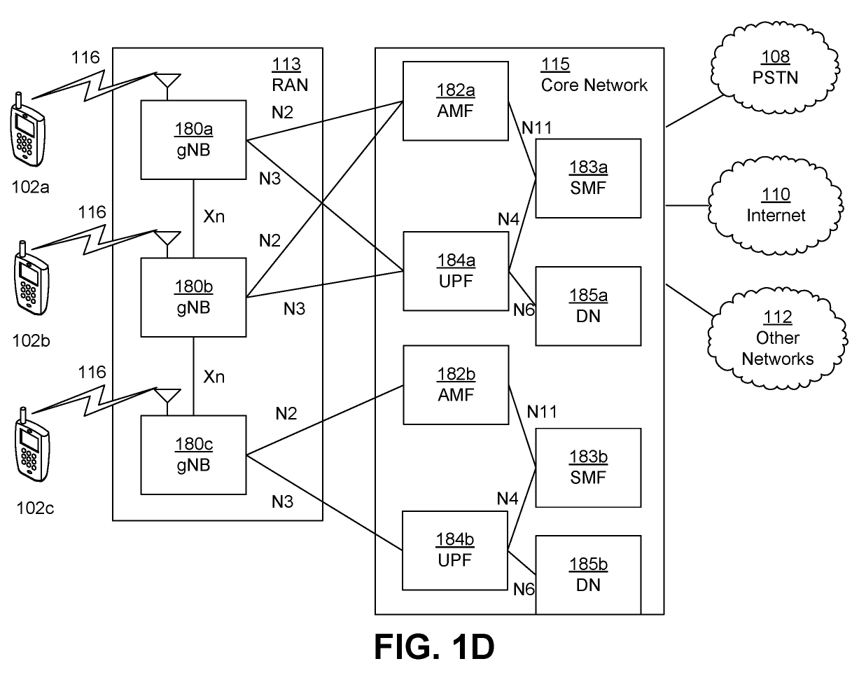

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180aand gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A use case for artificial intelligence/machine learning (AI/ML) with respect to beam management may be to predict one or more best beams among a set of beams with more accuracy and/or less overhead than legacy beam management procedures. Another use case for AI/ML with respect to beam management may be to predict qualities of beams, including unmeasured beams, based on the measured qualities of beams. The RS signals associated with a beam may be measured by a wireless transmit/receive unit (WTRU) (e.g., in current specification for beam management) to determine the beam quality, and a best beam(s) may be reported among the measured beams. In contrast, an AI/ML model in a WTRU (e.g., or gNB) may predict one or more beams out of one or more (e.g., all) possible beams, including those not measured by the WTRU (e.g., or gNB). An AI/ML model may also predict beam qualities of unmeasured beams. The inputs to the AI/ML model may be a set of beam measurements associated with a set of reference signals. The input set may be denoted by Set B. The AI/ML model may predict a best beam (e.g., a beam index) and/or qualities of beams from an output predicted set of beams, denoted by Set A. Here, Set B may be a subset of Set A. A single or a fixed resource set for Set B may be inefficient and/or limiting for BM-Case 2, where Set B comprises the whole beam set. In some scenarios (e.g., for a static or slow-moving WTRU), beam measurements from the whole beam set may not be needed to make an accurate prediction. Therefore, measurements from a subset (e.g., Top-M best measured beams) of Set B beams may be enough to make an accurate prediction. In other scenarios (e.g., high-speed WTRU or when prediction accuracy is low), regular beam measurements from a larger subset of beams may be needed to make an accurate prediction.

In the current standard specification, the WTRU may report up to four beams and associated beam qualities based on latest/recent measurements by the WTRU. The current specification does not support reporting of beams and beam qualities for temporal prediction use case, where all the beams associated with Set B are to be reported.

A single or a fixed resource set for Set B may be inefficient and/or limiting for BM-Case 2, where Set B comprises the whole beam set. In some scenarios (e.g., for a static or slow moving WTRU), beam measurements from the whole beam set may not be needed to make an accurate prediction. Therefore, measurements from a subset (e.g., Top-M best measured beams) of Set B beams may be enough to make an accurate prediction. In other scenarios (e.g., high-speed WTRU or when prediction accuracy is low), regular beam measurements from a larger subset of beams may be needed to make an accurate prediction.

Methods, systems, and instrumentalities for configuring, performing measurements, and reporting from multiple RS resource sets for BM-Case 2 (e.g., temporal prediction) are disclosed herein. One or more of the methods disclosed herein may be implemented by a wireless transmit/receive unit (WTRU) and/or a UE, for example via a processor thereof.

Dynamic activation (e.g., selecting for measurement/reporting) of RS resource sets based on one or more criteria (e.g., RS measurements, active beam, time, speed, gNB/NW configuration, WTRU capability, etc.) may be performed as disclosed herein.

A WTRU may receive a configuration of one or more of the following: one or more (e.g., a plurality of) RS resource sets containing RS resource configurations for Set A; one or more (e.g., a plurality of) RS resource sets containing RS resource configurations for Set B; one or more thresholds (e.g., threshold for beam quality, threshold for speed, time threshold); and/or one or more CSI report(s). For example, the configuration of one or more RS resource sets containing RS resource configurations for Set B may include one or more RS resource sets, with one or more (e.g., each) of the sets containing a subset of RS resource configurations associated with Set B. Alternatively, the WTRU may receive a configuration of RS resource groups associated with an RS resource set (e.g., the WTRU may receive a configuration of RS resource group IDs associated with an RS resource set and/or a per-group CRI configuration of RS resources within an RS resource set). One or more resource configurations for CSI report(s) (e.g., a first CSI-report resource for a first report size (e.g., measurement report for a first number of RS resource sets/ RS resource groups), a second CSI-report resource for a second report size (e.g., measurement report for a second number of RS resource sets/ RS resource groups)) may be received.

The WTRU may activate (e.g., select the number and/or IDs of RS resource sets/groups for measurement) one or more RS resource sets and/or RS resource groups associated with Set B and/or Set A based on one or more of the following: a first measurement time (e.g., latest) instance of RS measurements; a currently active beam; a speed of the WTRU; a time; a network (e.g., gNB) indication/configuration; and/or a WTRU capability/CPU (e.g., CSI-processing unit) availability.

The WTRU may activate (e.g., select the number and/or IDs of RS resource sets/groups for measurement) one or more RS resource sets and/or RS resource groups associated with Set B and/or Set A based on a first measurement time (e.g., latest) instance of RS measurements. For example, the WTRU may activate one or more RS resource sets/groups with the largest number of associated RSs with RS beam qualities measured at a first measurement time (e.g., latest) instance greater than a threshold. The WTRU may activate one or more RS resource sets/groups whose associated RSs have the largest overlap with the RSs associated with Top M beam qualities measured at a first measurement time instance. The WTRU may activate one or more RS resource sets/groups whose associated RS beam qualities measured at a first measurement time instance are greater than a threshold.

The WTRU may activate (e.g., select the number and/or IDs of RS resource sets/groups for measurement) one or more RS resource sets and/or RS resource groups associated with Set B and/or Set A based on a currently active beam. The WTRU may activate one or more RS resource sets/groups associated with one or more RS resource QCL-TypeD related with latest transmission of PDSCH/PDCCH.

The WTRU may activate (e.g., select the number and/or IDs of RS resource sets/groups for measurement) one or more RS resource sets and/or RS resource groups associated with Set B and/or Set A based on a speed of the WTRU. The WTRU may determine the number of RS resource sets/groups to activate based on the speed of the WTRU. For example, the WTRU may activate a first number of RS resource groups/sets when the WTRU speed is less than a threshold. For example, the WTRU may activate a second number (e.g., larger than first number) of RS resource groups/sets when the WTRU speed is greater than or equal to a threshold.

The WTRU may activate (e.g., select the number and/or IDs of RS resource sets/groups for measurement) one or more RS resource sets and/or RS resource groups associated with Set B and/or Set A based on a time. The WTRU may activate one or more RS resource sets/groups in one or more of the following ways: based on the condition that the time from the latest activation of an RS resource set/group is greater than or equal to a threshold; the WTRU determining the periodicity of one or more RS resource sets/groups based on other criteria (e.g., latest RS measurements, currently active beam, etc.); and/or based on a gNB/NW configuration/indication. For example, the WTRU may measure (e.g., and/or report) RS resource sets/groups associated with a currently active beam with a first periodicity and other RS resource sets/groups with a second (e.g., longer than first) periodicity. The WTRU may measure and/or report at configured/indicated time instances for different RS resource sets/groups.

The WTRU may activate (e.g., select the number and/or IDs of RS resource sets/groups for measurement) one or more RS resource sets and/or RS resource groups associated with Set B and/or Set A based on a network (e.g., gNB) indication/configuration. The WTRU may activate one or more RS resource sets/groups based on an indication/configuration of number of RS resource sets/groups to activate and/or resource set/group IDs to activate (e.g., based on MAC-CE activation of semi-persistent, and/or DCI indication of aperiodic CSI-report), and/or an associated ID and/or other AI/ML-related configuration.

The WTRU may activate (e.g., select the number and/or IDs of RS resource sets/groups for measurement) one or more RS resource sets and/or RS resource groups associated with Set B and/or Set A based on a WTRU capability/CPU (e.g., CSI-processing unit) availability. The WTRU may activate a first number of RS resource groups/sets when occupied CPU (O_{CPU}) is less than a CPU threshold, and a second number of RS resource groups when O_{CPU} is greater than or equal to the threshold.

The WTRU may perform measurements on RSs associated with activated RS resource sets associated with Set B and/or Set A. The WTRU may determine the measured beam qualities (e.g., RSRP, SINR, noise power) based on RS measurements.

The WTRU may transmit a periodic/semi-persistent/aperiodic CSI-report using a two-apart report and/or based on the configured resource (e.g., PUCCH) associated with the number and/or IDs of activated resource sets/groups. For a two-part report, the WTRU may indicate the number and/or IDs of measured RS resource sets/groups in the first part, and may report CRIs and/or associated beam qualities in second part. The WTRU may transmit the CSI-report based on the configured resource (e.g., PUCCH) associated with the number and/or IDs of activated resource sets/groups. The WTRU may report CRIs, beams qualities and/or IDs of measured RS resource sets/groups. For example, the WTRU may transmit the CSI-report on a first PUCCH for a first number of activated RS resource sets/groups. The WTRU may transmit the CSI-report on a second PUCCH for a second number of activated RS resource sets/groups. The first number may be the same as or different than (e.g., greater than or less than) the second number.

One or more of the methods disclosed herein may reduce RS measurement and reporting overhead for the WTRU, which may be especially useful for BM-Case2, which requires large number of RS measurements.

Hereinafter, “a,” “an,” and similar phrases are to be interpreted as “one or more” or “at least one.” Similarly, any term which ends with the suffix “(s)” is to be interpreted as “one or more” or “at least one.” The term “may” is to be interpreted as “may, for example.”

Artificial intelligence (AI) may be broadly defined as the behavior exhibited by machines. Such behavior may mimic cognitive functions to sense, reason, adapt and act.

Machine learning (ML) may refer to a type of algorithm that solves a problem based on learning through experience (“data”), without explicitly being programmed (“configuring set of rules”). Machine learning may be considered as a subset of AI. Different machine learning paradigms may be envisioned based on the nature of data or feedback available to the learning algorithm. For example, a supervised learning approach may involve learning a function that maps input to an output based on labeled training example, wherein a (e.g., each) training example may be a pair consisting of input and the corresponding output. For example, an unsupervised learning approach may involve detecting patterns in the data with no pre-existing labels. For example, a reinforcement learning approach may involve performing a sequence of actions in an environment to maximize the cumulative reward. In some solutions, it may be possible to apply machine learning algorithms using a combination or interpolation of approaches. For example, a semi-supervised learning approach may use a combination of a (e.g., small) amount of labeled data with a (e.g., large) amount of unlabeled data during training. In this regard semi-supervised learning may fall between unsupervised learning (e.g., with no labeled training data) and supervised learning (e.g., with only labeled training data).

Deep learning may refer to a class of machine learning algorithms that employ artificial neural networks (specifically DNNs) which were loosely inspired from biological systems. Deep Neural Networks (DNNs) are a special class of machine learning models inspired by human brain, wherein the input is linearly transformed and passed through non-linear activation function multiple times. DNNs typically consists of multiple layers, where a (e.g., each) layer consists of linear transformation and a given non-linear activation functions. The DNNs can be trained using the training data via back-propagation algorithm. Recently, DNNs have shown state-of-the-art performance in a variety of domains (e.g., speech, vision, natural language etc.) and for various machine learning settings supervised, un-supervised, and semi-supervised. The term AI/ML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (e.g., target) physical channel or signal according to a spatial relation with a reference to the second (e.g., reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication.”

The WTRU may receive a first (e.g., target) downlink channel or signal according to the same spatial domain filter or spatial reception parameter as a second (e.g., reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication.”

Hereafter, the term TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), consistent with the embodiments disclosed herein. Hereafter, the term Multi-TRP may be interchangeably used with one or more of MTRP, M-TRP, and multiple TRPs, consistent with the embodiments disclosed herein.

A WTRU may report a subset of channel state information (CSI) components, where CSI components may correspond to one or more of a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and/or other channel state information such as at least rank indicator (RI), channel quality indicator (CQI), precoding matrix indicator (PMI), Layer Index (LI), and/or the like.

Channel and/or interference measurements may be performed. A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following: a CSI report configuration; a CSI-RS resource set; and/or one or more NZP CSI-RS Resources. The CSI report configuration may include one or more of a CSI report quantity (e.g., Channel Quality Indicator (CQI), Rank Indicator (RI), Precoding Matrix Indicator (PMI), CSI-RS Resource Indicator (CRI), Layer Indicator (LI), etc.); a CSI report type (e.g., aperiodic, semi-persistent, periodic); a CSI report codebook configuration (e.g., Type I, Type II, Type II port selection, etc.); and/or a CSI report frequency. The CSI-RS resource set may include one or more of the following CSI Resource settings: NZP-CSI-RS Resource for channel measurement; NZP-CSI-RS Resource for interference measurement; and/or CSI-IM Resource for interference measurement. The NZP CSI-RS resource may include one or more of an NZP CSI-RS Resource ID; a periodicity and/or offset; QCL Info and TCI-state; and/or Resource mapping (e.g., number of ports, density, CDM type, etc.).

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included: SS-RSRP, CSI-RSRP, SS-SINR, CSI-SINR, RSSI, CLI-RSSI, and/or SRS-RSRP. Other parameters may be included.

SS reference signal received power (SS-RSRP) may be measured based on the synchronization signals (e.g., demodulation reference signal (DMRS) in PBCH or SSS). It may be defined as the linear average over the power contribution of the resource elements (REs) that carry the respective synchronization signal. In measuring the RSRP, power scaling for the reference signals may be required. If SS-RSRP is used for L1-RSRP, the measurement may be accomplished based on CSI reference signals in addition to the synchronization signals.

CSI-RSRP may be measured based on the linear average over the power contribution of the REs that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH or SSS). It may be defined as the linear average over the power contribution of the REs that carry the respective synchronization signal divided by the linear average of the noise and interference power contribution. If SS-SINR is used for L1-SINR, the noise and interference power measurement may be accomplished based on resources configured by higher layers.

CSI-SINR may be measured based on the linear average over the power contribution of the REs that carry the respective CSI-RS divided by the linear average of the noise and interference power contribution. If CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth).

Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth).

Sounding reference signals RSRP (SRS-RSRP) may be measured based on the linear average over the power contribution of the REs that carry the respective SRS.

Beam/CSI report configuration may be disclosed herein. A CSI report configuration (e.g., CSI-ReportConfigs) may be associated with a single BWP (e.g., indicated by BWP-Id), wherein one or more of the following parameters may be configured: CSI-RS resources and/or CSI-RS resource sets for channel and interference measurement; CSI-RS report configuration type, including periodic, semi-persistent, and aperiodic; CSI-RS transmission periodicity for periodic and semi-persistent CSI reports; CSI-RS transmission slot offset for periodic, semi-persistent and aperiodic CSI reports; CSI-RS transmission slot offset list for semi-persistent and aperiodic CSI reports; Time restrictions for channel and interference measurements; Report frequency band configuration (e.g., wideband/subband CQI, PMI, and so forth); Thresholds and modes of calculations for the reporting quantities (CQI, RSRP, SINR, LI, RI, etc.); Codebook configuration; Group based beam reporting; CQI table; Subband size; Non-PMI port indication; and/or Port Index, etc.

CSI-RS resource configuration may be disclosed herein. A CSI-RS Resource Set (e.g., NZP-CSI-RS-ResourceSet) may include one or more of CSI-RS resources (e.g., NZP-CSI-RS-Resource and CSI-ResourceConfig), wherein a WTRU may be configured with one or more of the following in a CSI-RS Resource: CSI-RS periodicity and slot offset for periodic and semi-persistent CSI-RS resources; CSI-RS resource mapping to define the number of CSI-RS ports, density, CDM-type, OFDM symbol, and/or subcarrier occupancy; The bandwidth part to which the configured CSI-RS is allocated; and/or the reference to the TCI-State including the QCL source RS(s) and/or the corresponding QCL type(s).

RS resource set configuration may be disclosed herein. One or more of the following configurations may be used for RS resource set. A WTRU may be configured with one or more RS resource sets. The RS resource set configuration may include one or more of following: an RS resource set ID; one or more RS resources for the RS resource set; repetition (e.g., on or off); aperioidic triggering offset (e.g., one of 0-6 slots); and/or TRS info (e.g., true or not).

RS resource configuration may be disclosed herein. One or more of following configurations may be used for RS resource. A WTRU may be configured with one or more RS resources. The RS resource configuration may include one or more of following: a RS resource ID; Resource mapping (e.g., REs in a PRB); Power control offset (e.g., one value of -8, …, 15); Power control offset with SS (e.g., -3 dB, 0 dB, 3 dB, 6 dB); Scrambling ID; Periodicity and offset; and/or QCL information (e.g., based on a TCI state).

A grant or an assignment may have one or more properties. Herein, a property of a grant or assignment may consist of at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); and/or any parameter provided in a DCI, by MAC or by RRC for the scheduling the grant or assignment.

Herein, an indication by DCI may consist of at least one of the following: an explicit indication by a DCI field or by RNTI used to mask CRC of the PDCCH; and/or an implicit indication by a property such as DCI format, DCI size, Coreset or search space, Aggregation Level, first resource element of the received DCI (e.g., index of first Control Channel Element), where the mapping between the property and the value may be signaled by RRC or MAC. Herein, RS may be interchangeably used with one or more of RS resource, RS resource set, RS port and RS port group, consistent with the embodiments disclosed herein.

Herein, RS may be interchangeably used with one or more of SSB, CSI-RS, SRS, DM-RS, TRS, PRS, and PTRS, consistent with the embodiments disclosed herein.

Herein, a reference signal may be interchangeably used with one or more of the following: Sounding reference signal (SRS); Channel state information – reference signal (CSI-RS); Demodulation reference signal (DM-RS); Phase tracking reference signal (PT-RS); and/or Synchronization signal block (SSB), consistent with the embodiments disclosed herein.

Herein, the term channel may be interchangeably used with one or more of following: PDCCH, PDSCH, Physical uplink control channel (PUCCH), Physical uplink shared channel (PUSCH), Physical random access channel (PRACH), etc., consistent with the embodiments disclosed herein.

A key performance indicator (KPI) may refer to, but is not limited to, one or more of the following: Signal quality (e.g., L1-RSRP, SINR, CQI, RSSI, RSRQ); Prediction performance (e.g., Percentage of the Top-1 genie-aided (e.g., best) beam is one of the Top-K predicted beams); Link quality (e.g., throughput, block error rate (BLER)); Data distribution (e.g., mean and/or variance of measured and/or predicted beam measurements); and/or RSRP (e.g., L1-RSRP) difference (e.g., the difference between measured and predicted RSRP of a beam).

Herein, a signal, channel, and message (e.g., as in DL or UL signal, channel, and message) may be used interchangeably, consistent with the embodiments disclosed herein.

Herein, a RS resource set may be interchangeably used with a RS resource and a beam group, consistent with the embodiments disclosed herein.

Herin, beam reporting may be interchangeably used with CSI measurement, CSI reporting and beam measurement, consistent with the embodiments disclosed herein.

Herein, the disclosed embodiments for beam resources prediction may be used for beam resources belonging to a single or multiple cells as well as single or multiple TRPs, consistent with the embodiments disclosed herein.

Herein, CSI reporting may be interchangeably used with CSI measurement, beam reporting and beam measurement, consistent with the embodiments disclosed herein.

Herein, a RS resource set may be interchangeably used with a beam group, consistent with the embodiments disclosed herein.

Herein, a Set B may be interchangeably used with a set of RS resource sets, beams, beam-pairs, beam RS resources, RS resources and a beam pattern.

Herein, Set B may be interchangeably used with measurement RS resources, measurement RS resource set, measurement beam resources, measurement beam resource set, measurement beam pattern, measurement TCI states, measurement TCI state group, etc., consistent with the embodiments disclosed herein.

Herein, a Set A may be interchangeably used with a set of - RS resource sets, beams, beam-pairs, beam RS resources, RS resources, and a beam pattern.

Herein, beam prediction accuracy may be interchangeably used with prediction accuracy, consistent with the embodiments disclosed herein.

Methods to configure multiple resource sets for a measurement set (e.g., Set B) are disclosed herein.

A WTRU may receive (e.g., via RRC/MAC-CE and/or DCI) a configuration of one or more of: one or more RS resource sets containing one or more RS resources associated with Set B; one or more RS resource groups associated with an RS resource set (e.g., the RS resource set associated with Set B); one or more RS resource sets containing one or more RS resources associated with Set A (e.g., based on the existence of a WTRU-side AIML model); one or more thresholds; and/or one or more CSI-reports.

The WTRU may receive (e.g., via RRC/MAC-CE and/or DCI) a configuration of one or more RS resource sets containing one or more RS resources associated with Set B. For example, the WTRU may receive a configuration of one or more RS resource sets, where a (e.g., each) resource set may contain a subset of RS resources associated with Set B.

The WTRU may receive (e.g., via RRC/MAC-CE and/or DCI) a configuration of one or more RS resource groups associated with an RS resource set (e.g., the RS resource set associated with Set B). The WTRU may receive a configuration of RS resource group IDs associated with an RS resource set. Additionally, the WTRU may receive a configuration of associations between RS resource IDs and RS resource groups.

The WTRU may receive (e.g., via RRC/MAC-CE and/or DCI) a configuration of one or more thresholds. The WTRU may receive one or more thresholds associated with one or more of the following: WTRU speed, time and/or beam prediction quality (e.g., based on the existence/operation of WTRU-sided model), beam/RS quality (e.g., RSRP, SINR, CQI, RSSI etc.), CPU (CSI processing unit) occupation threshold, etc.

The WTRU may receive (e.g., via RRC/MAC-CE and/or DCI) a configuration of one or more CSI-reports. The WTRU may receive one or more resource configurations for CSI-reports. For example, the WTRU may receive a configuration of a first CSI-report associated with a first report size. The WTRU may receive a configuration of a second CSI-report associated with a second report size. The report size may be associated/determined with/based on one or more of the following: the number of RS measurements to be reported; the size of an RS resource set and/or RS resource group (e.g., based on the size of largest resource set); the number of RS resource sets and/or RS resource groups associated with Set B that may be measured by the WTRU; and/or the number of future time prediction instances, denoted by N, and/or the number of predicted beams to be reported, denoted by K.

Methods to activate RS resource sets/groups may be performed as disclosed herein.

The term “RS resource set(s)” may be used interchangeably with the term “RS resource group(s),” consistent with the embodiments disclosed herein.

A WTRU may activate one or more RS resource sets and/or RS resource groups. Herein, the activation of an RS resource set(s)/RS resource group(s) may denote selection of the RS resource set(s)/group(s) for measurement of RSs associated with the RS resource set(s)/group(s). The WTRU may determine a number of RS resource set(s)/group(s), IDs of RS resource set(s)/group(s) to activate, and/or measurement(s) reporting periodicity of RS resource sets/groups based one or more of the following: RS measurements; an active beam; a WTRU (e.g., physical movement) speed; a time; a WTRU capability/capacity; a NW/gNB configuration/indication; and/or a prediction quality.

The WTRU may determine a number of RS resource set(s)/group(s), IDs of RS resource set(s)/group(s) to activate, and/or measurement(s) reporting periodicity of RS resource sets/groups based on RS measurements. The WTRU may activate one or more RS resource sets/groups based on a first measurement time (e.g., latest) instance of RS measurements.

The WTRU may activate one or more RS resource sets/groups with the largest number of associated beam/RS qualities (e.g., RSRP, CQI, SINR, RSSI) measured at a first measurement time (e.g., latest measurement) instance that is greater than a quality threshold.

The WTRU may activate one or more RS resource sets/groups whose associated RSs have the largest overlap (e.g., number of common beams/RSs) with beams/RSs associated with Top M (e.g., where the WTRU may be preconfigured and/or indicated with a value of M) beam/RS qualities measured at a first (e.g., latest) measurement time instance.

The WTRU may activate one or more RS resource sets/groups whose associated beams/RS qualities measured at first measurement time instance are greater than a beam/RS quality threshold.

The WTRU may activate one or more RS resource sets/groups whose associated beams/RSs’ overlap (e.g., number of common beams/RSs) with the beams/RSs associated with Top M (e.g., where the WTRU may be preconfigured and/or indicated with a value of M) beams/RSs qualities measured at a first measurement time instance is greater than a threshold.

The WTRU may determine a number of RS resource set(s)/group(s), IDs of RS resource set(s)/group(s) to activate, and/or measurement(s) reporting periodicity of RS resource sets/groups based on an active beam. The WTRU may activate one or more RS resource sets/groups associated with the beam/RS QCL-TypeD related with a first (e.g., latest) transmission PDCCH/PDSCH.

The WTRU may determine a number of RS resource set(s)/group(s), IDs of RS resource set(s)/group(s) to activate, and/or measurement(s) reporting periodicity of RS resource sets/groups based on a WTRU (e.g., physical movement) speed. The WTRU may determine the number and/or IDs of RS resource sets/groups to activate based on the speed of the WTRU (e.g., the speed at which the WTRU is moving). The WTRU may activate a first number of RS resource sets/groups when the WTRU movement speed is less than or equal to a speed threshold. The WTRU may activate a second number (e.g., which may be greater than the first number) of RS resource sets/groups when the WTRU movement speed is greater than or equal to the speed threshold. The WTRU may use this procedure in conjunction with other RS resource sets/groups activation criteria (e.g., active beam, RS measurements) to determine which RS resource sets/groups to activate.

The WTRU may activate a first RS resource set/group when the WTRU movement speed is less than or equal to a speed threshold. The WTRU may activate a second RS resource set/group (e.g., which may contain a larger number of RSs than the first RS resource set/group) when the WTRU movement speed is greater than the speed threshold.

The WTRU may determine a number of RS resource set(s)/group(s), IDs of RS resource set(s)/group(s) to activate, and/or measurement(s) reporting periodicity of RS resource sets/groups based on a time. The WTRU may activate one or more RS resource sets/groups based on the first (e.g., latest) activation time of an RS resource set. For example, the WTRU may activate one or more RS resource sets/groups when the difference between current time and the latest activation time of an RS resource set/group is greater or equal to a time threshold.

The WTRU may receive a configuration/indication (e.g., via RRC, MAC-CE, and/or DCI) of measurement time instances (e.g., X msec, slots, frames after reception of indication) and/or measurement/reporting periodicity (e.g., every Y msec, slots, frames) associated with one or more RS resource sets/groups. The WTRU may measure RS resource sets/groups based on the received configuration/indication at the configured/indicated time instances and/or with configured/indicated measurement/reporting periodicity.

The WTRU may determine the measurement/reporting periodicity of an RS resource set/group based on/in conjunction with one or more other criteria (e.g., active beam, RS measurements).

For example, the WTRU may measure/report measurements of the RS resource sets/groups associated with the active beam with a first periodicity. The WTRU may measure/report measurements of the RS resource sets/groups not associated with the active beam with a second periodicity (e.g., which may be greater than the first periodicity).

In another example, the WTRU may measure/reports measurements of RS resource sets/groups with a first periodicity whose associated RSs have an overlap (e.g., largest overlap, or number of common RSs greater than a threshold) with the Top M measured beams/RSs measured at a first measurement time instance. The WTRU may measure/reports measurements of RS resource sets/groups with a second (e.g., greater than the first) periodicity whose associated RSs have no overlap (e.g., or number of common RSs is less than a threshold) with the Top M measured beams/RSs measured at a first measurement time instance.

In a third example, the WTRU may measure/reports measurements of RS resource sets/groups with a first periodicity with the largest number of associated beams/RS qualities measured at first measurement time instance that is greater than quality threshold. The WTRU may measure/reports measurements of one or more other/remaining configured RS resource sets/groups with a second (e.g., greater than the first) periodicity.

The WTRU may determine a number of RS resource set(s)/group(s), IDs of RS resource set(s)/group(s) to activate, and/or measurement(s) reporting periodicity of RS resource sets/groups based on a WTRU capability/capacity. The WTRU may determine the number and/or IDs of RS resource sets/groups to activate based on WTRU CPU (e.g., CSI processing unit) capacity/capability.

The WTRU may activate a first number of RS resource sets/groups if the WTRU O_{CPU} (e.g., occupied CPU capacity) is greater than a CPU occupation threshold. The WTRU may activate a second number (e.g., which may be greater than the first number) of RS resource sets/groups if the WTRU O_{CPU} is less than or equal to the CPU occupation threshold. The WTRU may use this procedure in conjunction with other RS resource sets/groups activation criteria (e.g., active beam, RS measurements.

For example, the WTRU may activate a first RS resource set/group if the WTRU O_{CPU} is greater than a CPU occupation threshold. The WTRU may activate a second RS resource set/group (e.g., which may contain a larger number of RSs than the first RS resource set/group) if the WTRU O_{CPU} is less than or equal to the CPU occupation threshold.

The WTRU may determine a number of RS resource set(s)/group(s), IDs of RS resource set(s)/group(s) to activate, and/or measurement(s) reporting periodicity of RS resource sets/groups based on a NW/gNB configuration/indication. The WTRU may activate one or more RS resource sets/groups based on one or more of the following configurations/indications: AIML configuration/indications (e.g., Associated ID, type of prediction (e.g., BM-Case2, BM-Case1), and/or Set A/Set B size); and/or Activations/Indications (e.g., the WTRU may activate one or more RS resource sets based on MAC-CE activation information and/or DCI indications).

The WTRU may determine a number of RS resource set(s)/group(s), IDs of RS resource set(s)/group(s) to activate, and/or measurement(s) reporting periodicity of RS resource sets/groups based on a prediction quality. The WTRU may activate one or more RS resource sets/groups based on a prediction quality of a first (e.g., latest) prediction/inference instance. For example, the WTRU may activate a first number of RS resource sets/groups if the prediction quality (e.g., beam prediction accuracy e.g., Top-1/Top-K beam prediction accuracy) of a first prediction/inference instance is greater than a prediction quality threshold. The WTRU may activate a second number (e.g., which may be greater than a first number) of RS resource sets/groups if the WTRU prediction quality of a first prediction/inference instance is less than or equal to the prediction quality threshold.

Methods to report beams/RS measurements and/or predictions may be performed as disclosed herein. Herein, the term “RS resource sets” may be interchangeably used with the term “RS resource group,” consistent with the embodiments disclosed herein.

The WTRU may determine one or more activated RS resource sets. For example, the WTRU may receive a configuration of multiple RS resource sets. Among the multiple RS resource sets, the WTRU may determine the one or more RS resource sets to be activated based on one or more of an explicit indication and/or an implicit activation. For an explicit indication, the WTRU may receive an indication (e.g., from a gNB) that indicates which RS resource sets are activated. The indication may be received via one or more of RRC, MAC CE, and/or DCI. The indication may also indicate time and frequency resources that the RS resource sets are activated.

For implicit activation, the WTRU may activate the one or more RS resource sets without receiving an indication. For example, the WTRU may determine the one or more RS resource sets to be activated based on one or more of time/frequency resources, WTRU ID, QCL Type D, (physical/logical) cell ID, etc.

The WTRU may activate the one or more RS resource sets associated with one or more of an activated CSI report configuration, an activated CSI measurement config, an activated CSI resource config, etc.

The WTRU may perform measurements of RSs for prediction. For example, the WTRU may perform measurements on one or more activated RS resource sets associated with one or more of Set A, Set B, CSI report configuration, CSI resource configuration, and/or CSI measurement configuration for reporting predicted beam information.

The WTRU may determine a mode of measurement (e.g., for each RS resource/resource set). For example, the WTRU may determine one or more RS resources (e.g., for Set B). For a (e.g., each) RS resource, if the RS resource is activated, the WTRU may determine a first mode of measurement (e.g., measuring the activated RS resource). If the RS resource is not activated, the WTRU may determine a second mode of measurement (e.g., using latest measurements when the resource was activated and/or using a default value).

Based on the measurements, the WTRU may determine the measured beam qualities. The determined beam qualities may be one or more of RSRP, RSRQ, SINR, noise power, PDCCH hypothetical BLER, etc.

Based on the determined beam qualities, the WTRU may predict beam information. For example, the WTRU may use the determined beam qualities as inference input of an AI/ML model for beam prediction. Based on the inference of the AI/ML model, the WTRU may determine the predicted beam information.

The WTRU may indicate the predicted beam information (e.g., to a gNB). The predicted beam information (e.g., for one or more time instances) may be one or more of the following: one or more predicted best beams/RS resources/RS resource sets (e.g., Top-K beams); one or more measured RS resource sets (e.g., among the configured multiple RS resource sets); a number of activated resource sets; and/or measured/predicted beam qualities.

The predicted beam information (e.g., for one or more time instances) may be one or more measured RS resource sets (e.g., among the configured multiple RS resource sets). The WTRU may transmit the indication based on multiple parts. For example, the WTRU may indicate the number and/or IDs of measured RS resource sets/groups in a first part. The WTRU may report CRIs and/or associated beam qualities, which may be indicated in a second part. A number of candidate CSI RS resources and/or a number of associated beam qualities may be determined based on the indicated information in the first part.

The indication may be based on one or more of periodic CSI report, semi-persistent CSI report with PUCCH, semi-persistent CSI report with PUSCH, aperiodic CSI report, RS transmission (e.g., UL DMRS and/or SRS), PRACH, etc.

The WTRU may determine a resource for the indication based on the determined beam information. For example, the WTRU may be configured with two or more UL resources (e.g., PUCCH, PUSCH or PRACH resources). A (e.g., each) UL resource may be associated with a number of activated resource sets/groups. Based on the activated resource sets, the WTRU may transmit the CSI report (e.g., indicating the determined beam information) in a UL resource associated with the number of activated resource sets/groups.

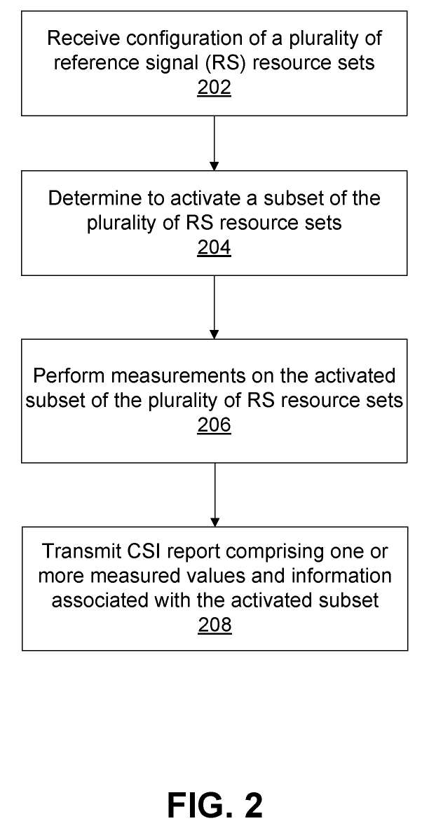

FIG. 2 illustrates an example of dynamic activation of RS resource sets based on one or more criteria.

As shown in FIG. 2, at 202 a WTRU may receive a configuration of one or more (e.g., a plurality of) RS resource sets. For example, the WTRU may receive a configuration of one or more of the following: one or more RS resource sets containing RS resource configurations for Set A; one or more RS resource sets containing RS resource configurations for Set B; one or more thresholds (e.g., threshold for beam quality, threshold for speed, time threshold); and/or one or more CSI report(s). For example, the configuration of one or more RS resource sets containing RS resource configurations for Set B may include one or more RS resource sets, with one or more (e.g., each) of the sets containing a subset of RS resource configurations associated with Set B. Alternatively, the WTRU may receive a configuration of RS resource groups associated with an RS resource set (e.g., the WTRU may receive a configuration of RS resource group IDs associated with an RS resource set and/or a per-group CRI configuration of RS resources within an RS resource set). One or more resource configurations for CSI report(s) (e.g., a first CSI-report resource for a first report size (e.g., measurement report for a first number of RS resource sets/ RS resource groups), a second CSI-report resource for a second report size (e.g., measurement report for a second number of RS resource sets/ RS resource groups)) may be received.

As shown in FIG. 2, at 204 the WTRU may determine to activate a subset of the plurality of RS resource sets received at 202. For example, the WTRU may (e.g., determine to) activate (e.g., select the number and/or IDs of RS resource sets/groups for measurement) one or more RS resource sets and/or RS resource groups associated with Set B and/or Set A based on one or more of the following: a first measurement time (e.g., latest) instance of RS measurements; a currently active beam; a speed of the WTRU; a time; a network (e.g., gNB) indication/configuration; and/or a WTRU capability/CPU (e.g., CSI-processing unit) availability.

The WTRU may activate (e.g., select the number and/or IDs of RS resource sets/groups for measurement) one or more RS resource sets and/or RS resource groups associated with Set B and/or Set A based on a first measurement time (e.g., latest) instance of RS measurements. For example, the WTRU may activate one or more RS resource sets/groups with the largest number of associated RSs with RS beam qualities measured at a first measurement time (e.g., latest) instance greater than a threshold. The WTRU may activate one or more RS resource sets/groups whose associated RSs have the largest overlap with the RSs associated with Top M beam qualities measured at a first measurement time instance. The WTRU may activate one or more RS resource sets/groups whose associated RS beam qualities measured at a first measurement time instance are greater than a threshold.

The WTRU may activate (e.g., select the number and/or IDs of RS resource sets/groups for measurement) one or more RS resource sets and/or RS resource groups associated with Set B and/or Set A based on a currently active beam. The WTRU may activate one or more RS resource sets/groups associated with one or more RS resource QCL-TypeD related with latest transmission of PDSCH/PDCCH.

The WTRU may activate (e.g., select the number and/or IDs of RS resource sets/groups for measurement) one or more RS resource sets and/or RS resource groups associated with Set B and/or Set A based on a speed of the WTRU. The WTRU may determine the number of RS resource sets/groups to activate based on the speed of the WTRU. For example, the WTRU may activate a first number of RS resource groups/sets when the WTRU speed is less than a threshold. For example, the WTRU may activate a second number (e.g., larger than first number) of RS resource groups/sets when the WTRU speed is greater than or equal to a threshold.

The WTRU may activate (e.g., select the number and/or IDs of RS resource sets/groups for measurement) one or more RS resource sets and/or RS resource groups associated with Set B and/or Set A based on a time. The WTRU may activate one or more RS resource sets/groups in one or more of the following ways: based on the condition that the time from the latest activation of an RS resource set/group is greater than a threshold; the WTRU determining the periodicity of one or more RS resource sets/groups based on other criteria (e.g., latest RS measurements, currently active beam, etc.); and/or based on a gNB/NW configuration/indication. For example, the WTRU may measure (e.g., and/or report) RS resource sets/groups associated with a currently active beam with a first periodicity and other RS resource sets/groups with a second (e.g., longer than first) periodicity. The WTRU may measure and/or report at configured/indicated time instances for different RS resource sets/groups.

The WTRU may activate (e.g., select the number and/or IDs of RS resource sets/groups for measurement) one or more RS resource sets and/or RS resource groups associated with Set B and/or Set A based on a network (e.g., gNB) indication/configuration. The WTRU may activate one or more RS resource sets/groups based on an indication/configuration of number of RS resource sets/groups to activate and/or resource set/group IDs to activate (e.g., based on MAC-CE activation of semi-persistent, and/or DCI indication of aperiodic CSI-report), and/or an associated ID and/or other AI/ML-related configuration.

The WTRU may activate (e.g., select the number and/or IDs of RS resource sets/groups for measurement) one or more RS resource sets and/or RS resource groups associated with Set B and/or Set A based on a WTRU capability/CPU (e.g., CSI-processing unit) availability. The WTRU may activate a first number of RS resource groups/sets when occupied CPU (O_{CPU}) is less than a CPU threshold, and a second number of RS resource groups when O_{CPU} is greater than or equal to the threshold.

As shown in FIG. 2, at 206 the WTRU may perform measurements on the activated subset of the plurality of RS resource sets. For example, the WTRU may perform measurements on RSs associated with activated RS resource sets associated with Set B and/or Set A. The WTRU may determine the measured beam qualities (e.g., RSRP, SINR, noise power) based on RS measurements.

As shown in FIG. 2, at 208 the WTRU may transmit a CSI report comprising one or more measured values and information associated with the activated subset. For example, the WTRU may transmit a periodic/semi-persistent/aperiodic CSI-report using a two-apart report and/or based on the configured resource (e.g., PUCCH) associated with the number and/or IDs of activated resource sets/groups. For a two-part report, the WTRU may indicate the number and/or IDs of measured RS resource sets/groups in the first part, and may report CRIs and/or associated beam qualities in second part. The WTRU may transmit the CSI-report based on the configured resource (e.g., PUCCH) associated with the number and/or IDs of activated resource sets/groups. The WTRU may report CRIs, beams qualities and/or IDs of measured RS resource sets/groups. For example, the WTRU may transmit the CSI-report on a first PUCCH for a first number of activated RS resource sets/groups. The WTRU may transmit the CSI-report on a second PUCCH for a second number of activated RS resource sets/groups. The first number may be the same as or different than (e.g., greater than or less than) the second number.

One or more of the methods disclosed herein may reduce RS measurement and reporting overhead for the WTRU, which may be especially useful for BM-Case2, which requires large number of RS measurements.

1. A wireless transmit/receive unit (WTRU) comprising a processor configured to:
receive, from a network, a configuration of a plurality of reference signal (RS) resource sets, wherein each RS resource set comprises one or more RS resources;
determine to activate a subset of the plurality of RS resource sets based on one or more of: a comparison between a measurement time instance and a first threshold, or a comparison between a time from latest activation of at least one of the RS resources and a second threshold;
perform measurements on the activated subset of the plurality of RS resource sets; and
transmit, to the network, a channel state information (CSI) report comprising one or more measured values and information associated with the activated subset of the plurality of RS resource sets.

2. The WTRU of claim 1, wherein the processor being configured to determine to activate the subset of the plurality of RS resource sets based on the comparison between the measurement time instance and the first threshold comprises the processor being configured to:
determine that a first RS resource set of the plurality of RS resource sets has a largest number of associated RSs with RS beam qualities measured at the measurement time instance that are greater than the threshold;
determine that a second RS resource set has a largest overlap with one or more RSs associated with highest beam qualities measured at the measurement time instance; and
activate the first RS resource set and the second RS resource set.

3. The WTRU of claim 1, wherein the measurement time instance is a latest measurement time.

4. The WTRU of claim 1, wherein the processor being configured to determine to activate the subset of the plurality of RS resource sets based on the comparison between the time from latest activation of the at least one of the RS resources and the second threshold comprises the processor being configured to:
determine, for each RS resource set of the plurality of RS resource sets, a respective time from latest activation;
determine that a respective time from latest activation for a first RS resource set of the plurality of RS resource sets is greater than the second threshold; and
activate the first RS resource set.

5. The WTRU of claim 1, wherein the processor is further configured to determine a number of RS resource sets to activate based on one or more of a speed of the WTRU or a capability of the WTRU.

6. The WTRU of claim 5, wherein the processor is further configured to:
compare the speed of the WTRU to a third threshold; and
determine the number of RS resource sets to activate based on the comparison between the speed of the WTRU and the third threshold.

7. The WTRU of claim 5, wherein the capability of the WTRU comprises a CSI-processing unit availability, and wherein the processor is further configured to:
compare the CSI-processing unit availability of the WTRU to a third threshold; and
determine the number of RS resource sets to activate based on the comparison between the CSI-processing unit availability of the WTRU and the third threshold.

8. The WTRU of claim 1, wherein the RS resource sets are associated with temporal downlink transmission prediction based on historic measurement results of a Set B.

9. The WTRU of claim 1, wherein the processor being configured to transmit the CSI report comprises the processor being configured to:
transmit a first part of the CSI report, wherein the first part of the CSI report comprises the information associated with the activated subset, wherein the information associated with the activated subset comprises a number of RS resource sets in the activated subset and a respective identifier associated with each RS resource set in the activated subset; and
transmit a second part of the CSI report, wherein the second part of the CSI report comprises the measured values.

10. A method implemented in a wireless transmit/receive unit (WTRU), the method comprising:
receiving, from a network, a configuration of a plurality of reference signal (RS) resource sets, wherein each RS resource set comprises one or more RS resources;
determining to activate a subset of the plurality of RS resource sets based on one or more of: a comparison between a measurement time instance and a first threshold, or a comparison between a time from latest activation of at least one of the RS resources and a second threshold;
performing measurements on the activated subset of the plurality of RS resource sets; and
transmitting, to the network, a channel state information (CSI) report comprising one or more measured values and information associated with the activated subset of the plurality of RS resource sets.

11. The method of claim 10, wherein determining to activate the subset of the plurality of RS resource sets based on the comparison between the measurement time instance and the first threshold comprises:
determining that a first RS resource set of the plurality of RS resource sets has a largest number of associated RSs with RS beam qualities measured at the measurement time instance that are greater than the threshold;
determining that a second RS resource set has a largest overlap with one or more RSs associated with highest beam qualities measured at the measurement time instance; and
activating the first RS resource set and the second RS resource set.

12. The method of claim 10, wherein the measurement time instance is a latest measurement time.

13. The method of claim 10, wherein determining to activate the subset of the plurality of RS resource sets based on the comparison between the time from latest activation of the at least one of the RS resources and the second threshold comprises:
determining, for each RS resource set of the plurality of RS resource sets, a respective time from latest activation;
determining that a respective time from latest activation for a first RS resource set of the plurality of RS resource sets is greater than the second threshold; and
activating the first RS resource set.

14. The method of claim 10, further comprising determining a number of RS resource sets to activate based on one or more of a speed of the WTRU or a capability of the WTRU.

15. The method of claim 14, further comprising:
comparing the speed of the WTRU to a third threshold; and
determining the number of RS resource sets to activate based on the comparison between the speed of the WTRU and the third threshold.

16. The method of claim 14, wherein the capability of the WTRU comprises a CSI-processing unit availability, and wherein the method further comprises:
comparing the CSI-processing unit availability of the WTRU to a third threshold; and
determining the number of RS resource sets to activate based on the comparison between the CSI-processing unit availability of the WTRU and the third threshold.

17. The method of claim 10, wherein the RS resource sets are associated with temporal downlink transmission prediction based on historic measurement results of a Set B.

18. The method of claim 10, wherein transmitting the CSI report comprises:
transmitting a first part of the CSI report, wherein the first part of the CSI report comprises the information associated with the activated subset, wherein the information associated with the activated subset comprises a number of RS resource sets in the activated subset and a respective identifier associated with each RS resource set in the activated subset; and
transmitting a second part of the CSI report, wherein the second part of the CSI report comprises the measured values.

19. A wireless transmit/receive unit (WTRU) comprising a processor configured to:
receive, from a network, a configuration of a plurality of reference signal (RS) resource sets, wherein each RS resource set comprises one or more RS resources;
determine to activate one or more RS resources of the plurality of RS resource sets based on a time value and a threshold;
perform measurements on the activated one or more RS resources; and
transmit, to the network, a channel state information (CSI) report comprising one or more measured values and information associated with the activated one or more RS resources.

20. The WTRU of claim 19, wherein the processor being configured to determine to activate the one or more RS resources of the plurality of RS resource sets based on the time value and the threshold comprises the processor being configured to:
determine, based on the time value, a measurement time instance of RS measurements;
determine that a first RS resource set has a largest number of associated RSs with RS beam qualities measured at the measurement time instance that are greater than the threshold; and
activate the first RS resource set.
